(19) United States
(12) Patent Application Publication
(10) Pub. No.: US 2014/0136650 A1
(43) Pub. Date: May 15, 2014

(54) METHOD AND APPARATUS FOR SUBSCRIPTION OF NOTIFICATIONS BASED ON CONTENT ITEMS

(71) Applicant: NOKIA CORPORATION, Espoo (FI)

(72) Inventors: Tuomas Veli KESKITALO, Oulunsalo (FI); Tero Mikael HALLA-AHO, Kukintotie (FI)

(73) Assignee: Nokia Corporation, Espoo (FI)

(21) Appl. No.: 13/675,654

(22) Filed: Nov. 13, 2012

(51) Int. Cl. H04L 29/08

(52) U.S. Cl. CPC H04L 67/02
USPC 709/217

(57) ABSTRACT

An approach is provided for subscribing to notifications based on operations associated with content items. The notification enabler determines at least one operation by at least one device associated with one or more content items. Next, the notification enabler processes and/or facilitates a processing of the one or more content items to determine at least one identification code. Then, the notification enabler causes, at least in part, a subscription to at least one notification channel associated with the one or more content items, one or more entities associated with the one or more content items, or combination thereof based, at least in part, on the at least one identification code.

### BACKGROUND

Service providers and device manufacturers (e.g., wireless, cellular, etc.) are continually challenged to deliver value and convenience to consumers by, for example, providing compelling network services. One area of interest has been the development of distributing messages to users, including notifications. For example, content item consumers may be interested in receiving updates or more information regarding the content items. However, the consumers must actively look for the updates or information on the content items. Also, content item providers cannot easily identify interested consumers and contact the interested consumers directly. As a result, content providers face significant challenges contacting consumers.

### SOME EXAMPLE EMBODIMENTS

Therefore, there is a need for an approach for subscribing to notifications based on operations associated with content items.

According to one embodiment, a method comprises determining at least one operation by at least one device associated with one or more content items. The method also comprises processing and/or facilitating a processing of the one or more content items to determine at least one identification code. The method further comprises causing, at least in part, a subscription to at least one notification channel associated with the one or more content items, one or more entities associated with the one or more content items, or a combination thereof based, at least in part, on the at least one identification code.

According to another embodiment, an apparatus comprises at least one processor, and at least one memory including computer program code for one or more computer programs, the at least one memory and the computer program code configured to, with the at least one processor, cause, at least in part, the apparatus to determine at least one operation by at least one device associated with one or more content items. The apparatus is also caused to process and/or facilitate a processing of the one or more content items to determine at least one identification code. The apparatus is further caused to cause, at least in part, a subscription to at least one notification channel associated with the one or more content items, one or more entities associated with the one or more content items, or a combination thereof based, at least in part, on the at least one identification code.

According to another embodiment, a computer-readable storage medium carries one or more sequences of one or more instructions which, when executed by one or more processors, cause, at least in part, an apparatus to determine at least one operation by at least one device associated with one or more content items. The apparatus is also caused to process and/or facilitate a processing of the one or more content items to determine at least one identification code. The apparatus is further caused to cause, at least in part, a subscription to at least one notification channel associated with the one or more content items, one or more entities associated with the one or more content items, or a combination thereof based, at least in part, on the at least one identification code.

According to another embodiment, an apparatus comprises means for determining at least one operation by at least one device associated with one or more content items. The apparatus also comprises means for processing and/or facilitating a processing of the one or more content items to determine at least one identification code. The apparatus further comprises means for causing, at least in part, a subscription to at least one notification channel associated with the one or more content items, one or more entities associated with the one or more content items, or a combination thereof based, at least in part, on the at least one identification code.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (or derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing the method of any of originally filed claims 1-10, 21-30, and 46-48.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of subscribing to notifications based on operations associated with content items, according to one embodiment;

FIG. 2A is a diagram of the components of the notification enabler, according to one embodiment;

FIG. 2B is a diagram of the components of the subscription platform, according to one embodiment;

FIG. 2C is a diagram of the components of the composer platform, according to one embodiment;

FIG. 3 is a flowchart of a process for subscribing to notifications based on operations associated with content items, according to one embodiment;

FIG. 4 is a flowchart of a process for creating an association between content items and entities, according to one embodiment;

FIG. 5 is a flowchart of a process for transmitting messages from the entities over the notification channels, according to one embodiment;

FIG. 6 is a flowchart of a process for verifying that the entities are authorized to transmit messages via notification channels associated with the content items and/or entities, according to one embodiment;

FIGS. 7A-7C are diagrams of user interfaces utilized in the processes of FIG. 3, according to various embodiments;

FIGS. 8A-8B are diagrams of user interfaces utilized in the processes of FIG. 3, according to various embodiments;

FIG. 9 is a diagram of hardware that can be used to implement an embodiment of the invention;

FIG. 10 is a diagram of a chip set that can be used to implement an embodiment of the invention; and

FIG. 11 is a diagram of a mobile terminal (e.g., handset) that can be used to implement an embodiment of the invention.

### DESCRIPTION OF SOME EMBODIMENTS

Examples of a method, apparatus, and computer program for subscribing to notifications based on operations associated with content items are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

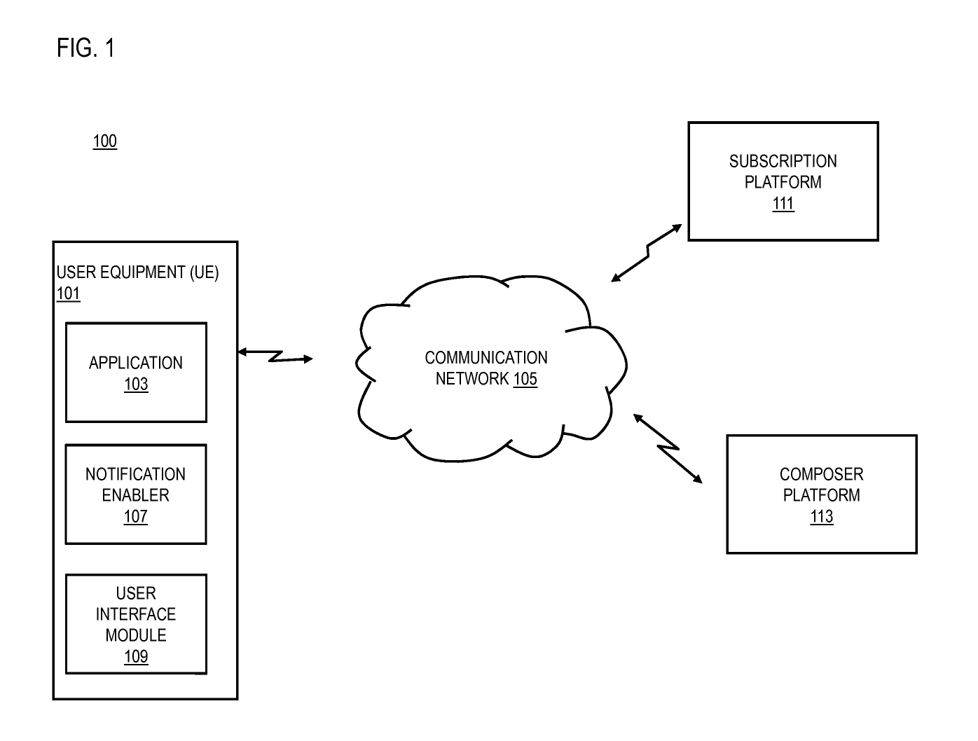

FIG. 1 is a diagram of a system capable of subscribing to notifications based on operations associated with content items, according to one embodiment. Service providers and device manufacturers (e.g., wireless, cellular, etc.) are continually challenged to deliver value and convenience to consumers by, for example, providing compelling network services. One area of interest has been the development of distributing messages to users, including notifications. For example, content item consumers may be interested in receiving updates or more information regarding the content items. However, the consumers must actively look for the updates or information on the content items. For example, for a particular website content item, an interested consumer must actively check the website for updates. Also, content item providers cannot easily identify interested consumers and contact the interested consumers directly. For example, content item providers historically rely on customers signing up for accounts or mailing lists in order to alert consumers to updates regarding content items. As a result, content providers face significant challenges in supplying interested consumers with updates that may interest them, and consumers face challenges in easily accessing the updates.

To address this problem, a system 100 of FIG. 1 introduces the capability to subscribe to notifications based on operations associated with content items. In one embodiment, the system 100 may determine at least one operation by at least one device associated with one or more content items, process the content items to determine at least one identification code, and cause, at least in part, a subscription to at least one notification associated with the content items, one or more entities associated with the content items, or a combination thereof based, at least in part, on the identification code. In another embodiment, the system 100 may also provide assurance that messages from the notification channels come from authorized entities associated with the content items.

For permitting subscriptions based on operations associated with content items, the system 100 may first determine a set of potential content items and operations performed on the content items that may trigger subscriptions. For example, the operations may include operations that connote user interest in the content item. In one scenario, the content item may include a webpage. Bookmarking the website, sharing the site, and/or commenting on site content may all be examples of operations that may indicate user interest in the content item. In the context of system 100, system 100 may initiate a subscription to one or more notification channels associated with the website in response to any of these exemplary operations. In another scenario, the content item may be media, including a picture, piece of music, a video, etc. The system 100 may determine that various operations on these content items may initiate subscriptions. For instance, downloading, sharing, and/or sampling the media may cause system 100 to cause a subscription. These are only exemplary content items and operations that may prompt system 100 to subscribe one or more devices to one or more content item and/or entity notification channels.

In another embodiment, the system 100 may create the subscription based, at least in part, on at least one identification code associated with the one or more content items. For example, an identification code for a website content item may include the uniform resource locator (URL) of the website. In other words, the identification code may serve as an identifier for the one or more notification channels associated with a particular content item. Determining the identification code associated with the content item may permit the system 100 to pinpoint the one or more notification channels for a given content item.

In one embodiment, the subscription may be to a notification channel associated with the content items, entities associated with the content items, or a combination thereof. In one embodiment, each content item or each entity has one notification channel. In another embodiment, each content item or entity may be associated with multiple notification channels. For example, a website may have multiple notification channels, each pertaining to a different type of notification. In one scenario, one notification channel may be for notifications regarding new website content, including new uploads or articles. Another notification channel may include offers linked to the website, for instance, if special discounts are provided to the website's notification channel subscribers.

In one embodiment, entities may include those authorized to distribute messages via the content item notification channel. For the example of a website content item, associated entities may include website developers, contributors, advertisers, etc. Should the content item be music, for instance, associated entities may include the recording artist, the record company, publicity personnel, concert venues, etc. In one embodiment, various entities may be associated with multiple notification channels as well. For example, one notification channel may be devoted to a certain type of content update, including music links. Another notification channel may contain only concert information. Many possibilities are available for the relationships between notification channels and associated content items and entities.

In another embodiment, the system 100 causes the subscription using at least one notification enabler. For example, the notification enabler may be a separate component from the components associated with performing the operation, presenting the content items, or a combination thereof. In having the notification enabler as a separate component, the system 100 may eliminate a least a developer application programming interface (API) for the content item providers so that consumers may receive messages from a notification channel rather than requiring notification APIs for each of the content items.

In one embodiment, the system 100 may verify that an entity requesting to compose and distribute one or more messages to one or more notification channels actually has authority to access the notification channels. For example, the system 100 may identify the entity using an identification code placed in the content item associated with the notification channels. In one embodiment, the system 100 may provide a console, separate from an application, where entities may compose and send messages (including notifications) to the subscribing device. In one embodiment, the console may include a web console interface separate from the operations. In one embodiment, the system 100 may require the entity to log into an account the entity maintains with the console. The entity may then register one or more content items that the system 100 may then recognize as linked to the entity. In other words, the entity asserts that it has authority to distribute messages to notification channels of these registered content items. For example, an entity may register the URL of a website content item.

After the link is created between the content item and entity, the system 100 may generate an identification code for the content item. In one embodiment, the identification code may be based, at least in part, on the entity login and registration. In one embodiment, the system 100 may encrypt the identification code and include the identification code in the content item. The system 100 may then use this identification code to verify the link between the content item and entity.

For example, an entity may log into the console of system 100 to create a message. The entity may provide a request identification code to indicate the notification channels (and thereby the content items) it wishes to access. To ensure that the entity actually has authority to distribute messages to the notification channels, the system 100 may load the content item associated with the notification channels and extract the identification code from the content item. The system 100 may then proceed to match the extracted identification code to the request identification code provided by the entity. If the two codes match, the system 100 may recognize the entity as having authority to distribute messages to the notification channel.

Then, the system 100 may publish the message created by the entity to the notification channels. In one embodiment, the notification channels of system 100 may push the messages to the devices subscribing to the notification channels. In one embodiment, the system 100 may prompt users to choose subscriptions and subscription settings. For example, upon installation of an application, the system 100 may prompt an end user to select whether or not to subscribe to a content item notification channel. In one scenario, the prompt may take the form of an “acceptance” window. In another example, the system 100 may prompt the end user to select whether or not to subscribe upon the first message from the notification channel. Alternately, the system 100 may create an “acceptance” window for the end user to select whether or not to continue to receive notifications upon sensing a given operation associated with a content item.

In one embodiment, the initial acceptance window may include a request for preference information associated with the messages, subscription, or a combination thereof. For example, the system 100 may prompt end users to select message frequency, message type, message display options, or a combination thereof. Message frequency may refer to how often the end user may permit notifications from a notification channel, for instance daily, weekly, monthly, etc. Message type may include text-only messages, rich notification messages, or a combination thereof. (Rich notifications may include icons, images, links, action buttons, etc. Action buttons may include actions specified by the entity in composing the message, for example, 1) open related website, 2) open store with a specific product, 3) open a given application, etc.)

Message display options may pertain to whether the message is a pop-up overlaid on the screen, as a scrolling line, a small preview window, etc. In one embodiment, system 100 may also integrate display options with notification services available at the end user devices and/or applications with API for supporting notifications. In another embodiment, the system 100 may also prompt users to set default settings for notifications, including whether to disable automatic subscriptions to notification channels in response to certain operations, unsubscribe to existing subscriptions, unsubscribe to notification channels associated with certain entities, etc.

In one embodiment, the system 100 may determine contextual information associated with notification channels, the devices, applications, contents, or a combination thereof. For example, contextual information may include technical specifications including available bandwidth or type of notifications supported. In such a scenario, a given channel may be devoted to text-only messages for low bandwidth devices and/or settings. Alternately, contextual information may include information such as location information associated with devices. Then, the system 100 may help developers target notifications, for example, to a certain geographic area. Other contextual information along these lines may include user profile information, user device activity information, or a combination thereof.

In a further embodiment, the system 100 may further target messages and notifications by profiling end users. For example, the system 100 may profile users according to attributes associated with applications (or groups of applications) installed or content items loaded on devices associated with the users. The system 100 may also profile users according to user interaction with notifications. In one scenario, the system 100 may determine that a given user does not respond to notifications, whereas another user tends to frequently click on links or media offered in notifications. The system 100 may then send notifications more frequently to the second user, rather than the first.

As shown in FIG. 1, the system 100 comprises a user equipment (UE) 101 having connectivity to browser 103, a notification enabler 107, a user interface module 109, a subscription platform 111, and a composer platform 113 via a communication network 105. By way of example, the communication network 105 of system 100 includes one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), wireless LAN (WLAN), Bluetooth®, Internet Protocol (IP) data casting, satellite, mobile ad-hoc network (MANET), and the like, or any combination thereof.

The UE 101 is any type of mobile terminal, fixed terminal, or portable terminal including a mobile handset, station, unit, device, multimedia computer, multimedia tablet, Internet node, communicator, desktop computer, laptop computer, notebook computer, netbook computer, tablet computer, personal communication system (PCS) device, personal navigation device, personal digital assistants (PDAs), audio/video player, digital camera/camcorder, positioning device, television receiver, radio broadcast receiver, electronic book device, game device, or any combination thereof, including the accessories and peripherals of these devices, or any combination thereof. It is also contemplated that the UE 101 can support any type of interface to the user (such as “wearable” circuitry, etc.).

In one embodiment, browser 103 may provide content items and opportunity to interact with the content items by way of operations. For example, the content items may include websites. Then, the browser 103 may load the websites on the UE 101 for users to interact with them. Operations may include expanding, responding to webpage content, and/or navigating through the webpage. Another operation may include bookmarking the webpage. In one embodiment, the notification enabler 107 may monitor activity of the browser 103, observing operations and acting in response to particular operations. For example, the operation of bookmarking a webpage may cause the notification enabler 107 to subscribe the UE 101 to a notification channel associated with the webpage. For another example, the operation of downloading a song may cause the notification enabler 107 to subscribe the UE 101 to a notification channel devoted to the artist of the song.

In one embodiment, the notification enabler 107 and user interface module 109 may work together to create settings for the subscription made by the notification enabler 107. The settings created at the notification enabler 107 and user interface module 109 may then adjust the subscriptions managed by the subscription platform 111. In one embodiment, the subscription platform 111 may manage the subscriptions devices keep to notification channels. For example, the subscription platform 111 may verify that entities are authorized that to distribute messages for given notification channels. As previously discussed, the subscription platform 111 may verify the entities by extracting an identification code from the content item and comparing the identification code with a request identification code provided by the entity requesting to distribute one or more messages. A match between the extracted identification code and request identification code may indicate that the entity is authorized to distribute the messages.

If the entities are indeed authorized, the subscription platform 111 may retrieve the entities' message(s) from the composer platform 113 and publish the message(s) to the notification channels. In publishing the messages to the notification channels, the subscription platform 111 may distribute the messages to the subscribing devices according to subscription settings given by the notification enabler 107.

In one embodiment, the composer platform 113 may permit the entities to create the association between themselves and one or more content items (and by extension, notification channels associated with the content items). For example, the composer platform 113 may request an entity login and registration of one or more content items. Based on the login and registration, the composer platform 113 may generate the identification code that later serves to verify that the entity is associated with the content item and authorized to distribute messages to the content item notification channel. In one embodiment, the composer platform 113 may also provide a console interface for the entities to compose their messages.

By way of example, the UE 101, browser 103, notification enabler 107, user interface module 109, subscription platform 111, and composer platform 113 communicate with each other and other components of the communication network 105 using well known, new or still developing protocols. In this context, a protocol includes a set of rules defining how the network nodes within the communication network 105 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

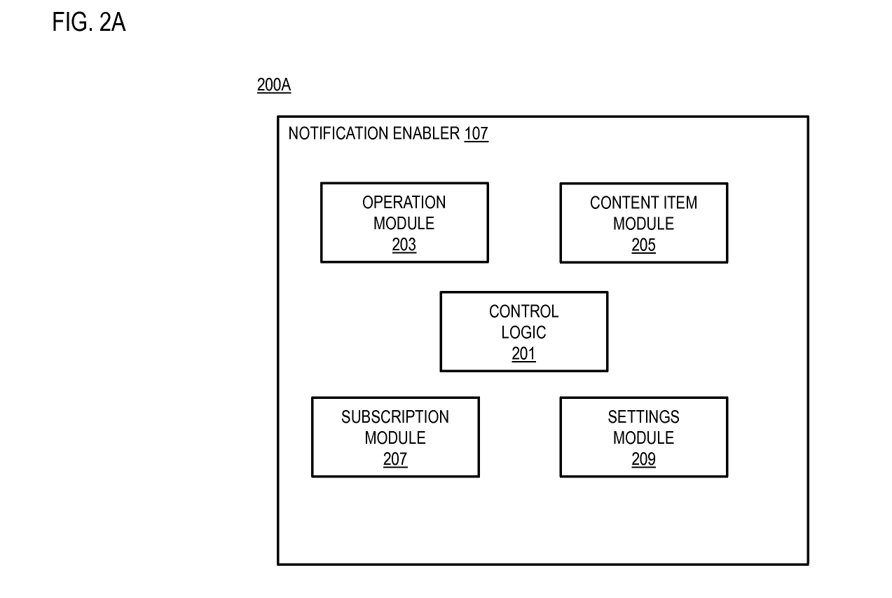

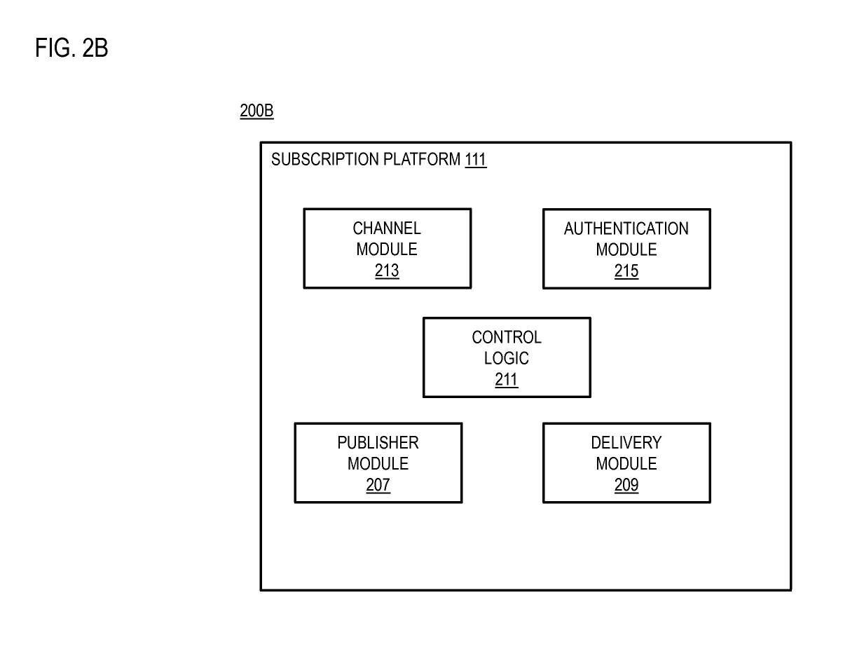

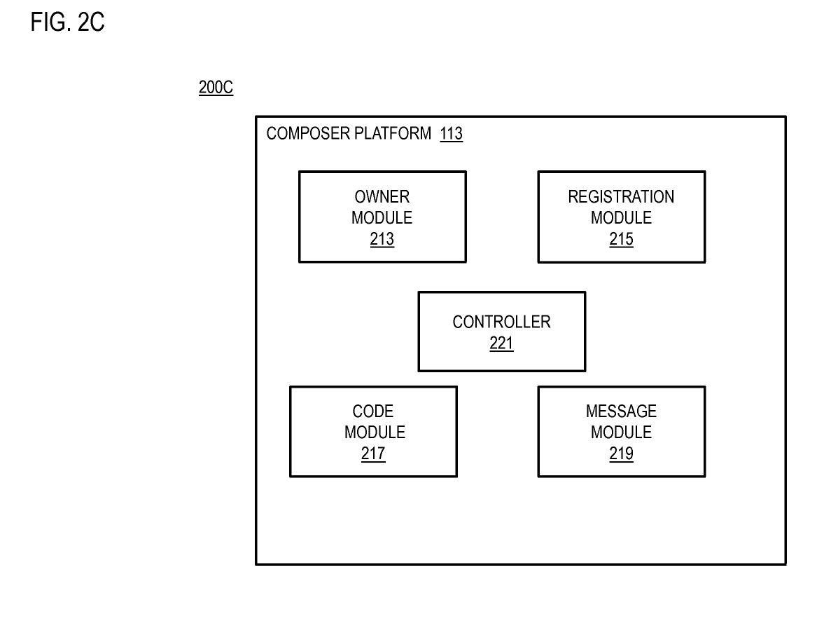

FIG. 2A is a diagram of the components of the notification enabler 107, according to one embodiment. By way of example, the notification enabler 107 includes one or more components for subscribing to notification channels based on operations associated with content items. It is contemplated that the functions of these components may be combined in one or more components or performed by other components of equivalent functionality. In this embodiment, the notification enabler 107 includes a control logic 201, operation module 203, content item module 205, subscription module 207, and settings module 209.

In one embodiment, the control logic 201 and operation module 203 may monitor the activity of at least one device. In a further embodiment, the control logic 201 and operation module 203 may determine at least one operation associated with one or more content items that may trigger causing a subscription to at least one notification channel. For example, the operation may include some operation indicating user interest in a particular content item. For instance, the content item may include web bookmarks and the operation may include creation of the web bookmark. Here, bookmarking a website may be an indication of interest in the website. In one scenario, the control logic 201 may observe that a user has entered a web page. Should the user then bookmark the web page, control logic and operation module 203 may then detect the new bookmark.

Alternately, where the content item is a media item, the control logic 201 and operation module 203 may define exemplary operations as playing, sample, sharing, and/or downloading the media item. In other words, the control logic 201 and operation module 203 may define the operations representative of interest, indicative of the user wanting to refer to the associated content item at a later date, or suggesting that the user may be receptive to notifications and news associated with the content item.

In another embodiment, the control logic 201 and content item module 205 may determine at least one identification code based on one or more content items. In one embodiment, control logic 201 and content item module 205 may record the content items associated with operations detected by the control logic 201 and operation module 203. Then, the control logic 201 and content item module 205 may determine at least one identification code with a particular content item so that the notification enabler 107 may further act on associating the UE 101 with the content item. For example, the content item may include a website where the identification code includes the URL of the website.

Based on the identification code given by the control logic 201 and content item module 205, the control logic 201 and subscription module 207 may cause a subscription to at least one notification channel associated with the one or more content items, entities associated with the content items, or a combination thereof. For example, the control logic 201 and subscription module 207 may determine the notification channel associated with the one or more content items and/or entities associated with the content items. In one scenario, each content item and/or entity has one associated notification channel. In another scenario, the content item and/or entity may have multiple notification channels. The multiple notifications channels may serve different purposes. For instance where a content item is a website, one notification channel may be for new content uploaded on the website, another may present reactions to the content from other users, yet another channel may include changes in the website itself, etc. The control logic 201 and subscription module 207 may subscribe the UE 101 to one or more of the notification channels the control logic 201 and subscription module 207 detect as associated with the content item.

Then, the control logic 201 and settings module 209 may permit the user to select how to receive the messages from the notification channel. For example, the control logic 201 and settings module 209 may work with the user interface module 109 to provide an interface for the user to select channel settings. Channel settings may include how often to display the notifications, how the notifications are actually displayed on the device, types of notifications to display, how to discontinue subscription, etc. Frequency of displaying the notifications may include whether to show notifications on a constant, daily, weekly, or monthly basis.

Choosing notification display may include selecting whether the notifications are to pop up on the device screen, a preview of the notification appears, a mere indicator that a notification is present, etc. It may also include whether the notification, preview, or indicator is to appear fully, as an overlay, as an icon, as a display that disappears if an interaction with the display is not detected, etc. For example, a user may opt to have an icon appear showing that a notification is present, but have the icon fade out after a given amount of time if the user does not click on the icon to view the notification. Types of notifications to display may include the user selecting specific notification channels to subscribe or unsubscribe to where a given content item and/or entity is associated with more than one notification channel. Options for unsubscribing may include selecting to manually unsubscribe, setting a default option to manually subscribe, automatically unsubscribe if a notification channel is inactive and/or the user does not frequently respond to the notifications, automatically unsubscribing if the content item is removed from the bookmarks, etc.

Furthermore, the control logic 201 and settings module 209 may provide the option to disable automatic subscriptions and/or unsubscribe to any existing subscriptions. In other words, the control logic 201 and settings module 209 may offer settings, not only for specific subscriptions for particular channels, but also offer management settings for all the subscriptions of the UE 101.

FIG. 2B is a diagram of the components of the subscription platform 111 according to one embodiment. By way of example, the subscription platform 111 includes one or more components for providing messages to notification channels. It is contemplated that the functions of these components may be combined in one or more components or performed by other components of equivalent functionality. In this embodiment, the subscription platform 111 includes a control logic 211, channel module 213, authentication module 215, publisher module 217, and delivery module 219. In one embodiment, the control logic 211 and channel module 213 may manage all the available notification channels associated with content items. As previously discussed, in one embodiment, each content item and/or entity may be associated with one notification channel. Alternately, multiple notification channels may be associated with various entities and/or content items. The control logic 211 and channel module 213 may manage the relations between notification channels, entities, and content items.

In another embodiment, the control logic 211 and authentication module 215 may cause an authentication of the entities for access to the console interface, notification channel, or a combination thereof. For example, the control logic 211 and authentication module 215 may access a content item and extract an identification code associated with the content item. For example if the content item is a web page, the control logic 211 and authentication module 215 may load the webpage and extract an identification code associated with the webpage. For instance, the identification code may include the webpage URL and/or an identification of an entity.

In a further embodiment, the control logic 211 and authentication module 215 may detect an entity requesting access to the console interface. Then, the control logic 211 and authentication module 215 may process and/or facilitate a processing of the request to determine a request identification code. In one embodiment, the control logic 211 and authentication module 215 may then determine whether the extracted identification code is associated with the request identification code. For example, the control logic 211 and authentication module 215 may determine that the extracted identification code matches the request identification code.

In one embodiment, the extracted identification code is encrypted, for example, by the composer platform 113. The control logic 211 and authentication module 215 may then decrypt the extracted identification code to compare against the request identification code. If the comparison shows a correct association, the control logic 211 and authentication may cause authentication of the requesting entity, verifying that the entity, in fact, has the authority to distribute messages via the content item notification channel.

In one embodiment, the control logic 211 and publisher module 217 may then retrieve the composed message from the composer platform 113 and publish it to the notification channel. In one embodiment, the control logic 211 and delivery module 219 may determine how the notifications are delivered to the devices. For example, the control logic 211 and delivery module 219 may apply settings dictated at the notification enabler 107 to the subscriptions managed by the channel module 213 to deliver the notifications according to preference set at each UE 101.

In one embodiment, the control logic 211 and delivery module 219 may determine when a first message of a subscribed channel is distributed. For such a case, the control logic 211 and delivery module 219 may determine to present a confirmation message, for instance, asking the user to confirm whether he/she would like to subscribe to the content item notification channel or opt out. In one embodiment, if the user chooses to opt out, control logic 211 and delivery module 219 may cause the UE 101 to unsubscribe from the notification channel. The control logic 201 and channel module 213 may consequently alter the record subscriptions accordingly.

FIG. 2C is a diagram of the components of the composer platform 113 according to one embodiment. By way of example, the composer platform 113 includes one or more components for providing messages to notification channels. It is contemplated that the functions of these components may be combined in one or more components or performed by other components of equivalent functionality. In this embodiment, the composer platform 113 includes a controller 221, entity module 223, registration module 225, code module 227, and message module 229.

In one embodiment, the controller 221 and entity module 223 may determine one or more entities associated with one or more content items. In other words, the controller 221 and entity module 223 may detect one or more entities logging into the composer platform 113. As previously discussed, the one or more entities may include any entity with the authority to distribute notification associated with the content items. For example where the content item is a website, an associated entity may include one or more publishers, website administrators, authors, contributors, owners of the domain name, etc. Where the content item is a piece of music, associated entities may include one or more musicians, record companies, music distributors, publicity personnel, etc. In one embodiment, one or more associated entities may wish to send notifications to subscribers or UEs 101 with interest in the content item, as indicated via respective notification enablers 107 and the subscription platform 111. The controller 221 and entity module 223 may then determine the entity via an entity login and account managed by the controller 221 and entity module 223.

Then, the associated entities may register a content item to be associated with the associated entities. In one embodiment, the controller 221 and registration module 225 may register a content item with an associated entity. For example, the associated entities may provide some identification associated with one or more content items. In the exemplary scenario of a content item that is a website, the associated entities may register a URL. In doing so, the controller 221 and registration module 225 may link the entity with the content item so that the entity is an entity associated with the now-registered content item.

In one embodiment, the controller 221 and code module 227 may subsequently generate an identification code from the entity login and content item identification. For instance, the controller 221 and code module 227 may generate an identification code based, at least in part, on the entity login and URL of a website content item. In a further embodiment, the controller 221 and code module 227 may cause an encryption of the generated identification code, where the content item is associated with the identification code in encrypted form.

In a further embodiment, the controller 221 and code module 227 may cause the identification code to be included in the content item such that the subscription platform 111 and composer platform 113 may extract the identification code to verify that the entity logged in, in fact, is the entity associated with the content item. In other words, the identification code contributes to verifying that the entity identified by the controller 221 and entity module 223 actually has authority to distribute messages via the one or more notification channels associated with the content item.

In another embodiment, the composer platform 113 may further include the controller 221 and message module 229 for the associated entity to compose their messages for the notification channels. In one embodiment, the controller 221 and message module 229 may provide a presentation of at least one console interface for exchanging messages. For example, the console interface may include a web console interface so the entities may construct the messages without requiring additional support from the content items or UEs 101.

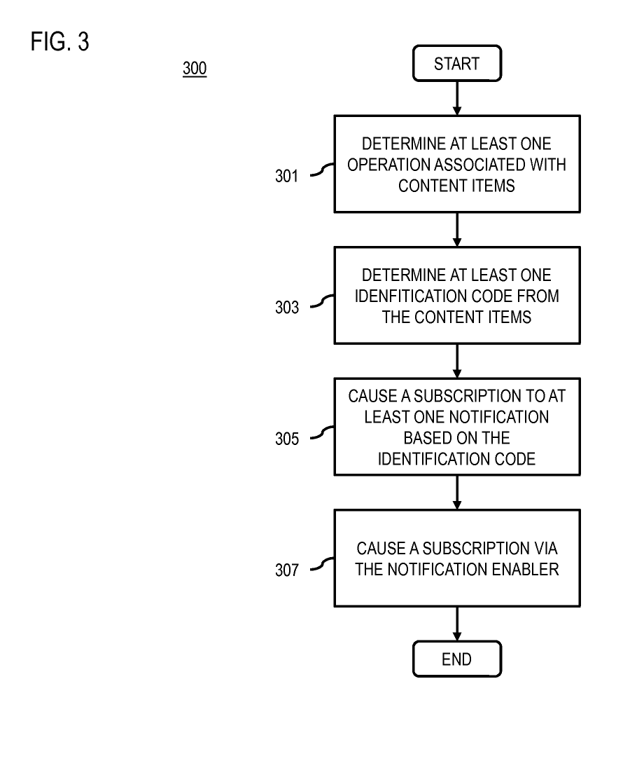

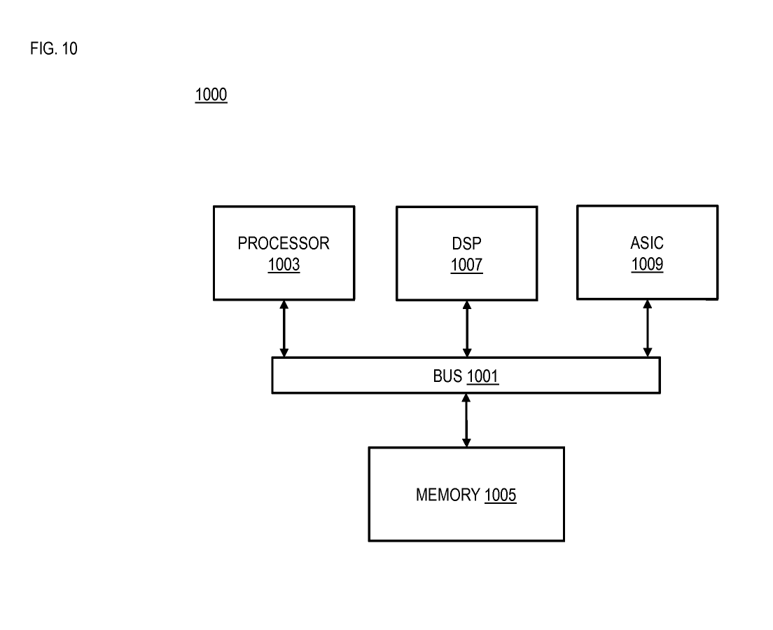

FIG. 3 is a flowchart of a process for subscribing one or more devices to notification channels based on operations associated with content items, according to one embodiment. In one embodiment, the notification enabler 107 performs the process 300 and is implemented in, for instance, a chip set including a processor and a memory as shown in FIG. 10. In one embodiment, the control logic 201 may determine at least one operation by at least one device associated with one or more content items (step 301). For example, the control logic 201 may perform step 301 wherein the one or more content items include, at least in part, one or more web bookmarks, and wherein the at least one operation includes, at least in part, a creation of the one or more web bookmarks. For step 303, the control logic 201 may process and/or facilitate a processing of the one or more content items to determine at least one identification code. Then, the control logic 201 may cause, at least in part, a subscription to at least one notification channel associated with the one or more content items, one of more entities associated with the one or more content items, or a combination thereof based, at least in part, on the at least one identification code (step 305).

In one embodiment, the system 100 may perform the process 300 wherein the determining of the at least one operation, the determining of the at least one identification code, the subscription to the at least one notification channel, or a combination thereof is performed by at least one notification enabler (step 307). In one embodiment, the system 100 may perform the process 300 wherein the at least one notification enabler is a separate component from one or more other components associated with performing the at least one operation, presenting the one or more content items, or a combination thereof.

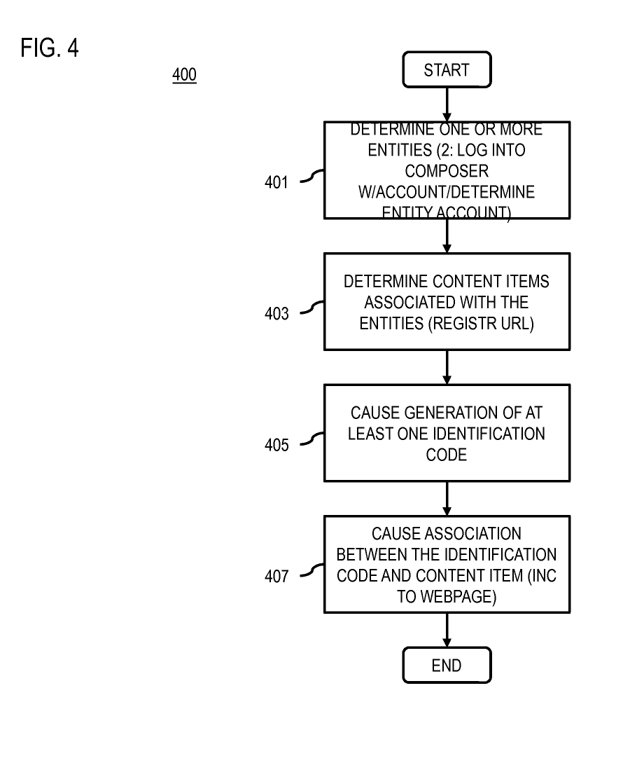

FIG. 4 is a flowchart of a process for creating an association between content items and entities, according to one embodiment. In one embodiment, the composer platform 113 performs the process 400 and is implemented in, for instance, a chip set including a processor and a memory as shown in FIG. 10. In one embodiment, system 100 may include a console interface for exchanging messages over the notification channel. In one embodiment, the controller 221 may determine one or more entities associated with the one or more content items, the at least one notification channel, or a combination thereof, and cause, at least in part, an authentication of the one or more entities for access to the at least one console interface, the at least one notification channel, or a combination thereof (step 401). For example, the controller 221 may determine one or more entities associated with one or more accounts at the console interface. The controller 221 may permit the one or more entities to access their associated accounts by logging into the console interface. In logging in, the controller 221 may cause the authentication.

In a further embodiment, authentication by control logic 211 may include determining a request for a registration of the one or more entities, the one or more content items, or a combination thereof (step 403). For example, the controller 221 may register the URL of a website in conjunction with registering the entities. In doing so, the composer platform 113 may link the website and entity. Then, the controller 221 may also cause, at least in part, a generation of the at least one identification code for the one or more entities to include with the one or more content items (steps 405-407). In an even further embodiment, the controller 221 may cause, at least in part, an encryption of the at least one identification code, wherein the one or more content items are associated with the at least one identification code in an encrypted form.

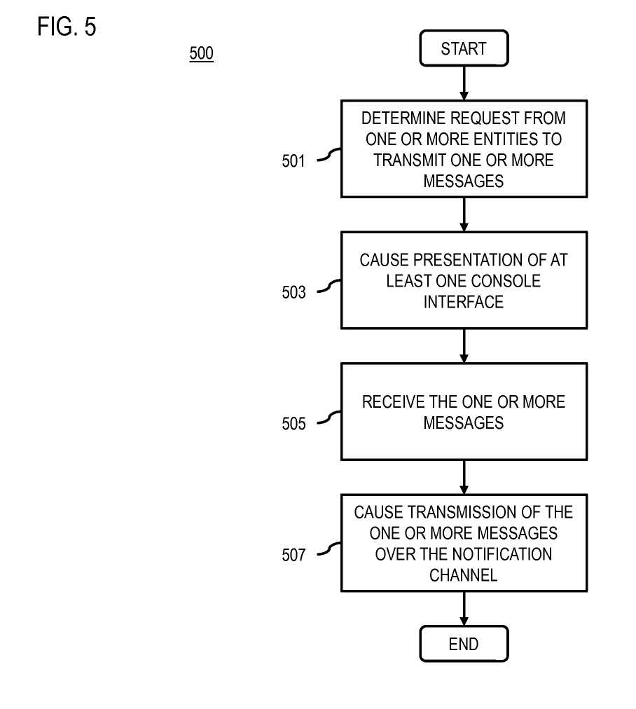

FIG. 5 is a flowchart of a process for transmitting messages from the entities over the notification channels, according to one embodiment. In one embodiment, the composer platform 113 performs the process 500 and is implemented in, for instance, a chip set including a processor and a memory as shown in FIG. 10. In one embodiment, the control logic 211 may determine another request form the one or more entities to transmit one or more messages over the at least one notification channel (step 501). To permit the one or more entities to compose their messages, the control logic 211 may cause, at least in part, a presentation of at least one console interface for exchanging one or more messages over the at least one notification channel (step 503). From the console interface, the control logic 211 may receive the message entered by the entities (step 505) and cause, at least in part, a transmission of the one or more messages over the at least one notification channel based, at least in part, on the authentication (step 507).

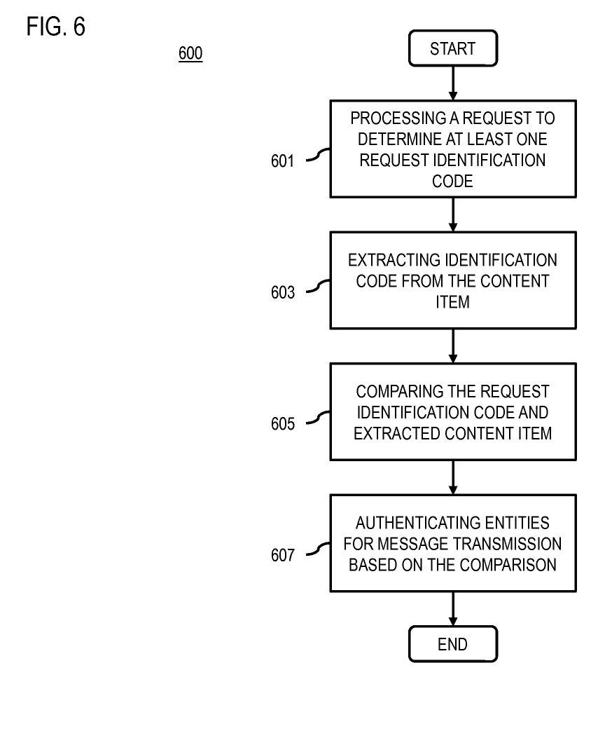

FIG. 6 is a flowchart of a process for verifying that the entities are authorized to transmit messages via notification channels associated with the content items and/or entities, according to one embodiment. In one embodiment, the composer platform 113 performs the process 600 and is implemented in, for instance, a chip set including a processor and a memory as shown in FIG. 10. In one embodiment, the controller 221 may process and/or facilitate a processing of the another request to determine at least one request identification code (step 601). For example, step 603 may include the control logic 211 extracting the identification code from the content item. In one scenario, the identification code is associated with the entity and website URL. Next, the control logic 211 may compare the request identification code and extracted identification code, wherein the authorization is based, at least in part, on a comparison of the at least one request identification code against the at least one identification code determined from the one or more content items (step 605). If the codes match, the control logic 211 may proceed to authenticate entities for transmission of messages over the notification channels (step 607).

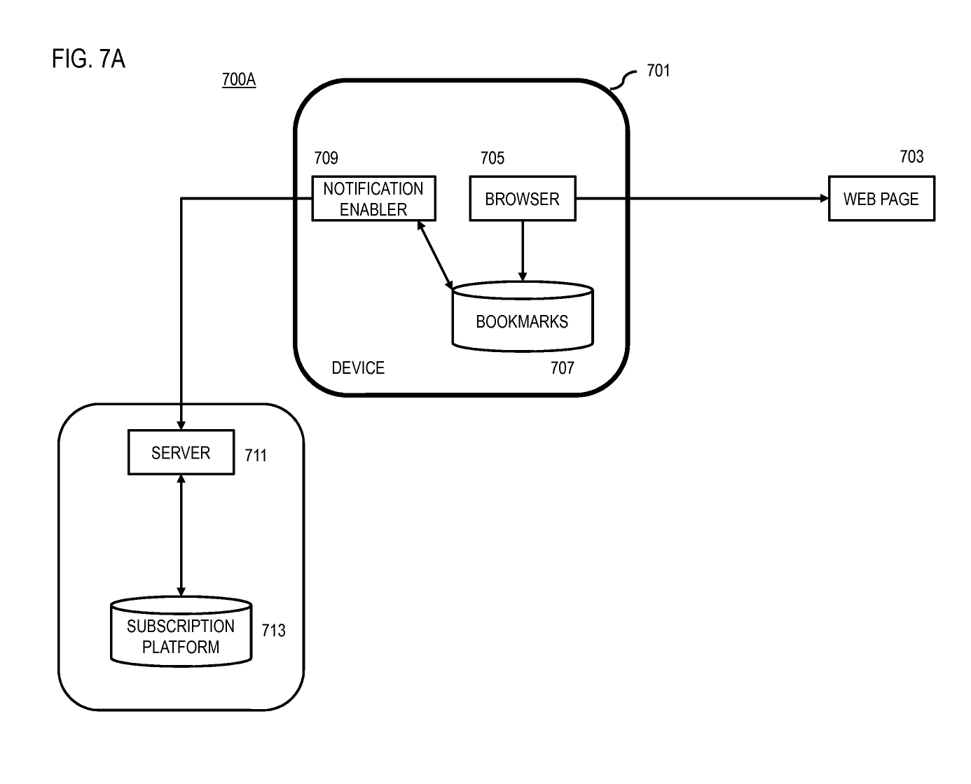

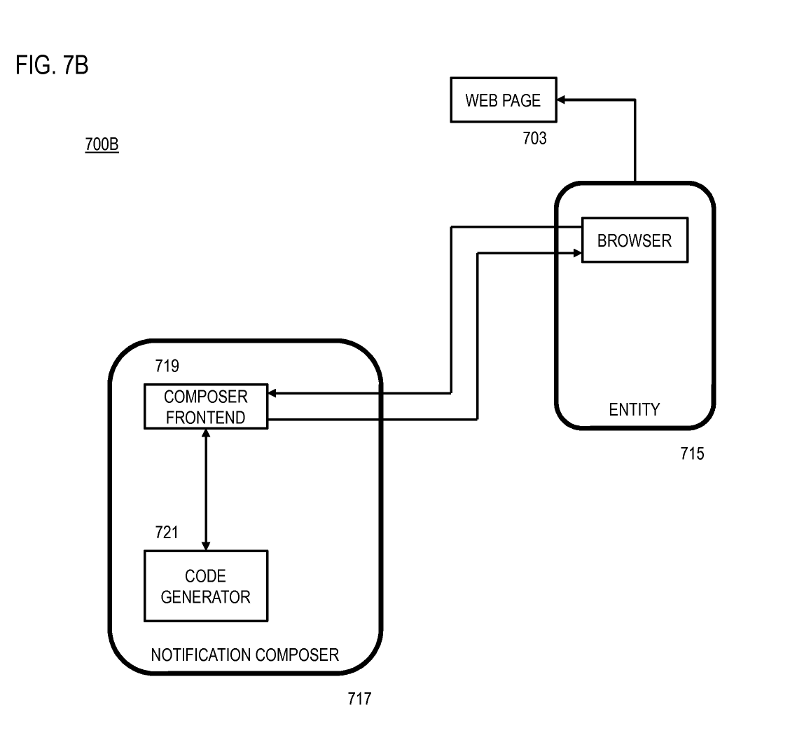

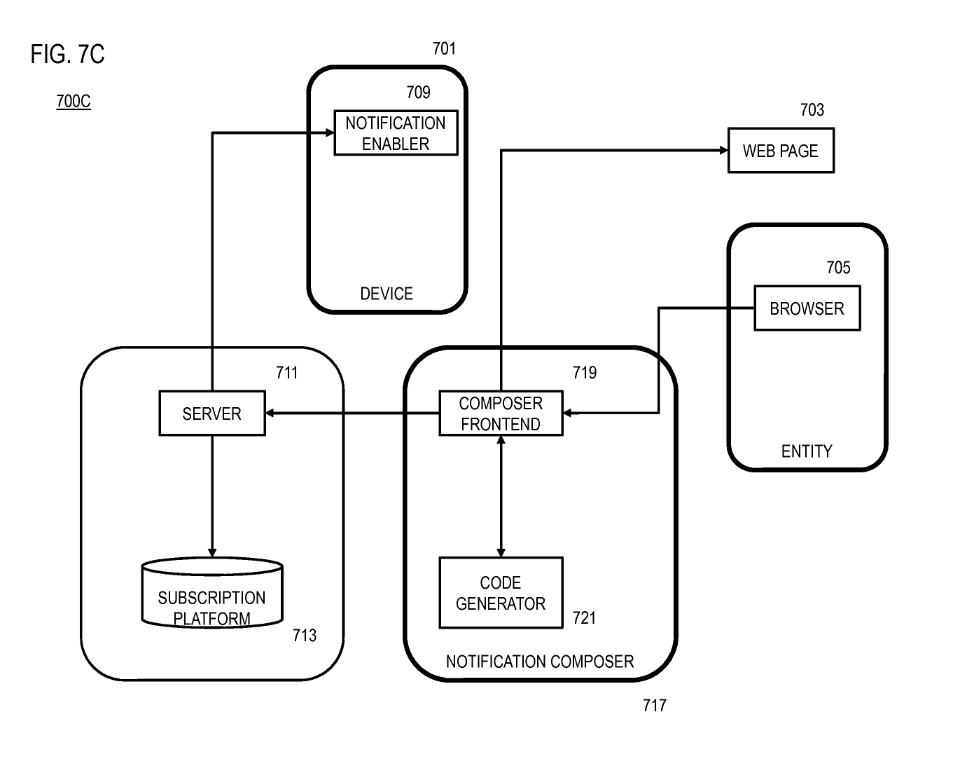

FIGS. 7A-7C are illustrations of the processes of FIGS. 3-6, according to various embodiments. FIG. 7A shows one embodiment where an operation performed on a content item prompts subscription is created in response to an operation performed on a content item. In one exemplary embodiment, a device 701 may load a content item, including a website 703 via the browser 705. Then, a user may store the website 703 or denote the website 703 as a bookmarked website saved to the bookmarks 707 associated with browser 705. A notification enabler 709 on the device 501 may then detect the bookmark and create a subscription for the website 703 of the new bookmark. To do so, the notification enabler 709 may contact the subscription server 711, which may then subscribe the device 701 to the notification channel associated with the website 703 as dictated by subscription platform 713.

FIG. 7B shows one embodiment where an entity may create an association between itself and one or more content items for which it may distribute notifications. An entity 715 may contact a notification composer 717 to create messages for the notification channel. The entity 715 may only distribute messages for notification channels where the entity is authorized to distribute messages to the associated content items. As previously discussed, the entity 715 may contact the message composer frontend 719 on the notification composer 717 by logging into an account at the message composer frontend 719 that is associated with the entity. The composer frontend 719 may then obtain an identification code for the content item from identification code generator 721. In one embodiment, the identification code is based, at least in part, on the entity login and content item. The notification composer 717 may then return the identification code to the browser 705, where the browser 705 may then place the identification code at the website 703. This process may link the exemplary website 703 with the entity. The identification code is then the indicator that the entity has authority to distribute messages to the notification channel associated with website 703.

FIG. 7C illustrates the entire process, where an entity may log into the notification composer 717 to create a notification message. To verify that the entity is authorized to create messages for a notification channel, the notification composer frontend 719 may retrieve the identification code at the website 703. The notification composer 717 may then verify that the identification code at the website 703 is the identification code associated with the logged in entity. If the identification code matches, the message created by the entity is sent to the subscription server 711. In one embodiment, the subscription server 711 may then retrieve the subscribers of the notification channels from the subscription platform 713. Once the subscribers have been identified, the subscription server 711 may deliver the message to notification enablers 709 at subscribing devices 701.

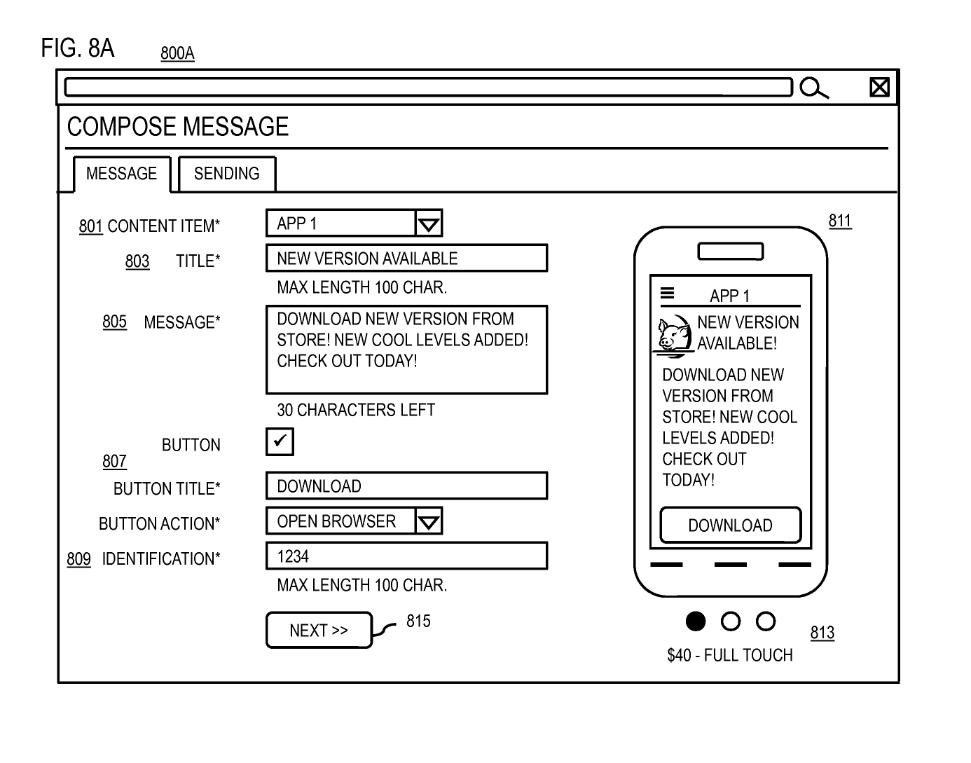

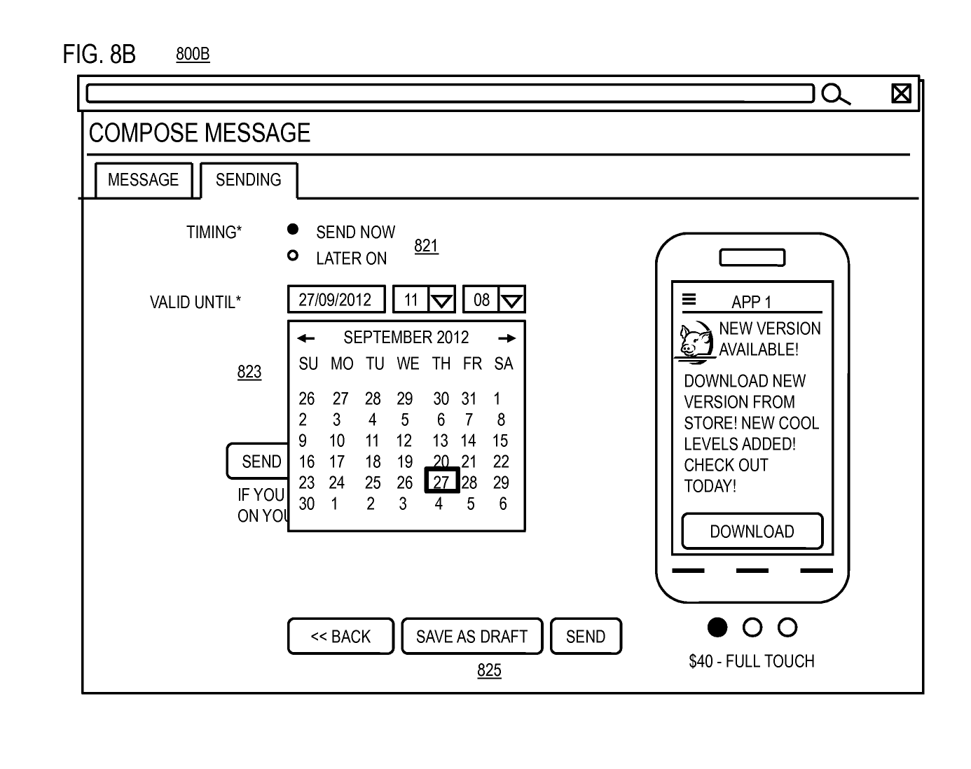

FIGS. 8A-8B are diagrams of user interfaces utilized in the processes of FIG. 3, according to various embodiments. For one embodiment, this interface may be a web console interface separate from components associated with performing the operation, presenting the content items, or a combination thereof. For example, the composer platform 113 may provide the console independently online, eliminating the need for each content item to have its own API for notifications. In one embodiment, the console interface 800A may include a drop-down menu 801 to select a content item or group of content items where the message is directed. For example, the drop-down menu may include content items with associated content item channels. Next, console interface 800A may provide a title line 803. In one embodiment, the title line 803 may have a maximum character length. In one embodiment, the content of the title line 803 may help entities categorize or organize messages. For example, the console interface 800A may permit entities to re-use messages or compile a set of message templates or standard messages. In one instance, console interface 800A may permit entities to search for these methods using the title.

Message box 805 may provide publishers a space to create their messages. In one embodiment, message box 805 may include a character counter. Further message customization may be available via button options 807 where publishers may opt to add buttons or additional functionality to the message and name the buttons. Identification 809 may provide further fine-grain selection of content items. For example, different versions of a content item may be denoted by different identifiers. Entering a particular identifier may permit publishers to further target message distribution. In another example, identification 809 may include the identification code, request identification code, or a combination thereof. Preview 811 may display a version of how users see the notification. Pricing information 813 may also be part of the console interface 800A. The console interface 800A may include more than one page of options. Page button 815 may permit entities to move on to more message creation options.

FIG. 8B is a further diagram 800B of a console interface 800B for composing one or more messages. In one embodiment, the console interface 800B may include timing options 821 for example, for sending immediately, or setting a future time. The timing options 821 may then offer calendar 823. Upon message completion, console interface 800B may permit further publication options 825, including modifying the message (by revisiting console interface 800B), saving the message as a draft, or sending.

The processes described herein for subscribing to notifications based on operations associated with content items may be advantageously implemented via software, hardware, firmware or a combination of software and/or firmware and/or hardware. For example, the processes described herein, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

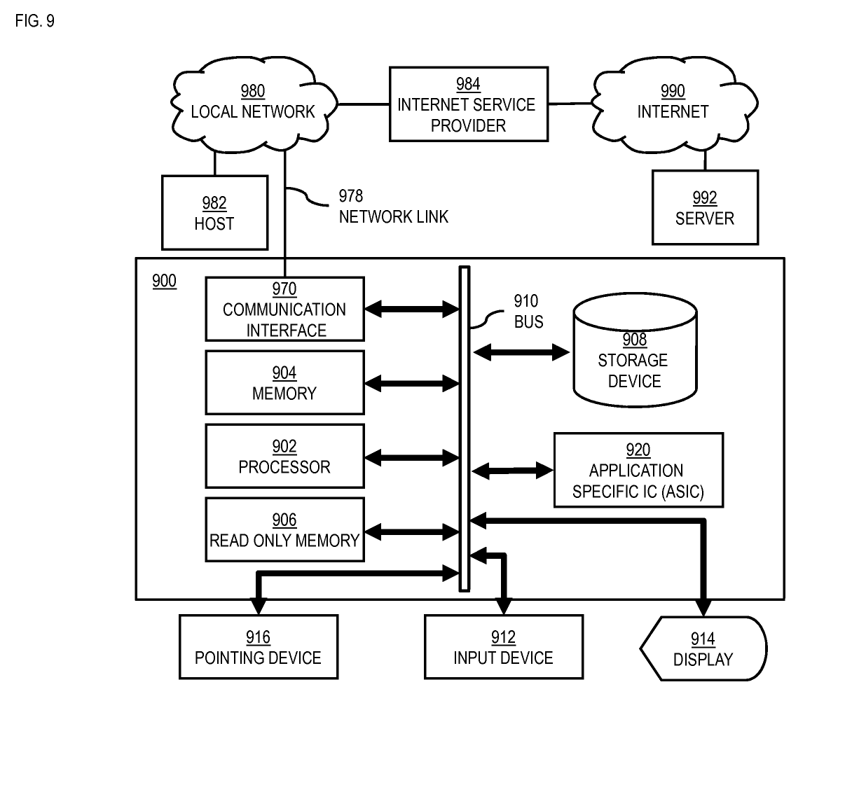

FIG. 9 illustrates a computer system 900 upon which an embodiment of the invention may be implemented. Although computer system 900 is depicted with respect to a particular device or equipment, it is contemplated that other devices or equipment (e.g., network elements, servers, etc.) within FIG. 9 can deploy the illustrated hardware and components of system 900. Computer system 900 is programmed (e.g., via computer program code or instructions) to subscribing to notifications based on operations associated with content items as described herein and includes a communication mechanism such as a bus 910 for passing information between other internal and external components of the computer system 900. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 900, or a portion thereof, constitutes a means for performing one or more steps of subscribing to notifications based on operations associated with content items.

A bus 910 includes one or more parallel conductors of information so that information is transferred quickly among devices coupled to the bus 910. One or more processors 902 for processing information are coupled with the bus 910.

A processor (or multiple processors) 902 performs a set of operations on information as specified by computer program code related to subscribing to notifications based on operations associated with content items. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 910 and placing information on the bus 910. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 902, such as a sequence of operation codes, constitute processor instructions, also called computer system instructions or, simply, computer instructions. Processors may be implemented as mechanical, electrical, magnetic, optical, chemical, or quantum components, among others, alone or in combination.

Computer system 900 also includes a memory 904 coupled to bus 910. The memory 904, such as a random access memory (RAM) or any other dynamic storage device, stores information including processor instructions for subscribing to notifications based on operations associated with content items. Dynamic memory allows information stored therein to be changed by the computer system 900. RAM allows a unit of information stored at a location called a memory address to be stored and retrieved independently of information at neighboring addresses. The memory 904 is also used by the processor 902 to store temporary values during execution of processor instructions. The computer system 900 also includes a read only memory (ROM) 906 or any other static storage device coupled to the bus 910 for storing static information, including instructions, that is not changed by the computer system 900. Some memory is composed of volatile storage that loses the information stored thereon when power is lost. Also coupled to bus 910 is a non-volatile (persistent) storage device 908, such as a magnetic disk, optical disk or flash card, for storing information, including instructions, that persists even when the computer system 900 is turned off or otherwise loses power.

Information, including instructions for subscribing to notifications based on operations associated with content items, is provided to the bus 910 for use by the processor from an external input device 912, such as a keyboard containing alphanumeric keys operated by a human user, a microphone, an Infrared (IR) remote control, a joystick, a game pad, a stylus pen, a touch screen, or a sensor. A sensor detects conditions in its vicinity and transforms those detections into physical expression compatible with the measurable phenomenon used to represent information in computer system 900. Other external devices coupled to bus 910, used primarily for interacting with humans, include a display device 914, such as a cathode ray tube (CRT), a liquid crystal display (LCD), a light emitting diode (LED) display, an organic LED (OLED) display, a plasma screen, or a printer for presenting text or images, and a pointing device 916, such as a mouse, a trackball, cursor direction keys, or a motion sensor, for controlling a position of a small cursor image presented on the display 914 and issuing commands associated with graphical elements presented on the display 914, and one or more camera sensors 994 for capturing, recording and causing to store one or more still and/or moving images (e.g., videos, movies, etc.) which also may comprise audio recordings. In some embodiments, for example, in embodiments in which the computer system 900 performs all functions automatically without human input, one or more of external input device 912, display device 914 and pointing device 916 may be omitted.

In the illustrated embodiment, special purpose hardware, such as an application specific integrated circuit (ASIC) 920, is coupled to bus 910. The special purpose hardware is configured to perform operations not performed by processor 902 quickly enough for special purposes. Examples of ASICs include graphics accelerator cards for generating images for display 914, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 900 also includes one or more instances of a communications interface 970 coupled to bus 910. Communication interface 970 provides a one-way or two-way communication coupling to a variety of external devices that operate with their own processors, such as printers, scanners and external disks. In general the coupling is with a network link 978 that is connected to a local network 980 to which a variety of external devices with their own processors are connected. For example, communication interface 970 may be a parallel port or a serial port or a universal serial bus (USB) port on a personal computer. In some embodiments, communications interface 970 is an integrated services digital network (ISDN) card or a digital subscriber line (DSL) card or a telephone modem that provides an information communication connection to a corresponding type of telephone line. In some embodiments, a communication interface 970 is a cable modem that converts signals on bus 910 into signals for a communication connection over a coaxial cable or into optical signals for a communication connection over a fiber optic cable. As another example, communications interface 970 may be a local area network (LAN) card to provide a data communication connection to a compatible LAN, such as Ethernet. Wireless links may also be implemented. For wireless links, the communications interface 970 sends or receives or both sends and receives electrical, acoustic or electromagnetic signals, including infrared and optical signals, that carry information streams, such as digital data. For example, in wireless handheld devices, such as mobile telephones like cell phones, the communications interface 970 includes a radio band electromagnetic transmitter and receiver called a radio transceiver. In certain embodiments, the communications interface 970 enables connection to the communication network 105 for subscribing to notifications based on operations associated with content items to the UE 101.

The term “computer-readable medium” as used herein refers to any medium that participates in providing information to processor 902, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 908. Volatile media include, for example, dynamic memory 904. Transmission media include, for example, twisted pair cables, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, an EEPROM, a flash memory, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 920.

Network link 978 typically provides information communication using transmission media through one or more networks to other devices that use or process the information. For example, network link 978 may provide a connection through local network 980 to a host computer 982 or to equipment 984 operated by an Internet Service Provider (ISP). ISP equipment 984 in turn provides data communication services through the public, world-wide packet-switching communication network of networks now commonly referred to as the Internet 990.

A computer called a server host 992 connected to the Internet hosts a process that provides a service in response to information received over the Internet. For example, server host 992 hosts a process that provides information representing video data for presentation at display 914. It is contemplated that the components of system 900 can be deployed in various configurations within other computer systems, e.g., host 982 and server 992.

At least some embodiments of the invention are related to the use of computer system 900 for implementing some or all of the techniques described herein. According to one embodiment of the invention, those techniques are performed by computer system 900 in response to processor 902 executing one or more sequences of one or more processor instructions contained in memory 904. Such instructions, also called computer instructions, software and program code, may be read into memory 904 from another computer-readable medium such as storage device 908 or network link 978. Execution of the sequences of instructions contained in memory 904 causes processor 902 to perform one or more of the method steps described herein. In alternative embodiments, hardware, such as ASIC 920, may be used in place of or in combination with software to implement the invention. Thus, embodiments of the invention are not limited to any specific combination of hardware and software, unless otherwise explicitly stated herein.

The signals transmitted over network link 978 and other networks through communications interface 970, carry information to and from computer system 900. Computer system 900 can send and receive information, including program code, through the networks 980, 990 among others, through network link 978 and communications interface 970. In an example using the Internet 990, a server host 992 transmits program code for a particular application, requested by a message sent from computer 900, through Internet 990, ISP equipment 984, local network 980 and communications interface 970. The received code may be executed by processor 902 as it is received, or may be stored in memory 904 or in storage device 908 or any other non-volatile storage for later execution, or both. In this manner, computer system 900 may obtain application program code in the form of signals on a carrier wave.

Various forms of computer readable media may be involved in carrying one or more sequence of instructions or data or both to processor 902 for execution. For example, instructions and data may initially be carried on a magnetic disk of a remote computer such as host 982. The remote computer loads the instructions and data into its dynamic memory and sends the instructions and data over a telephone line using a modem. A modem local to the computer system 900 receives the instructions and data on a telephone line and uses an infra-red transmitter to convert the instructions and data to a signal on an infra-red carrier wave serving as the network link 978. An infrared detector serving as communications interface 970 receives the instructions and data carried in the infrared signal and places information representing the instructions and data onto bus 910. Bus 910 carries the information to memory 904 from which processor 902 retrieves and executes the instructions using some of the data sent with the instructions. The instructions and data received in memory 904 may optionally be stored on storage device 908, either before or after execution by the processor 902.

FIG. 10 illustrates a chip set or chip 1000 upon which an embodiment of the invention may be implemented. Chip set 1000 is programmed to subscribing to notifications based on operations associated with content items as described herein and includes, for instance, the processor and memory components described with respect to FIG. 9 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 1000 can be implemented in a single chip. It is further contemplated that in certain embodiments the chip set or chip 1000 can be implemented as a single “system on a chip.” It is further contemplated that in certain embodiments a separate ASIC would not be used, for example, and that all relevant functions as disclosed herein would be performed by a processor or processors. Chip set or chip 1000, or a portion thereof, constitutes a means for performing one or more steps of providing user interface navigation information associated with the availability of functions. Chip set or chip 1000, or a portion thereof, constitutes a means for performing one or more steps of subscribing to notifications based on operations associated with content items.

In one embodiment, the chip set or chip 1000 includes a communication mechanism such as a bus 1001 for passing information among the components of the chip set 1000. A processor 1003 has connectivity to the bus 1001 to execute instructions and process information stored in, for example, a memory 1005. The processor 1003 may include one or more processing cores with each core configured to perform independently. A multi-core processor enables multiprocessing within a single physical package. Examples of a multi-core processor include two, four, eight, or greater numbers of processing cores. Alternatively or in addition, the processor 1003 may include one or more microprocessors configured in tandem via the bus 1001 to enable independent execution of instructions, pipelining, and multithreading. The processor 1003 may also be accompanied with one or more specialized components to perform certain processing functions and tasks such as one or more digital signal processors (DSP) 1007, or one or more application-specific integrated circuits (ASIC) 1009. A DSP 1007 typically is configured to process real-world signals (e.g., sound) in real time independently of the processor 1003. Similarly, an ASIC 1009 can be configured to performed specialized functions not easily performed by a more general purpose processor. Other specialized components to aid in performing the inventive functions described herein may include one or more field programmable gate arrays (FPGA), one or more controllers, or one or more other special-purpose computer chips.

In one embodiment, the chip set or chip 1000 includes merely one or more processors and some software and/or firmware supporting and/or relating to and/or for the one or more processors.

The processor 1003 and accompanying components have connectivity to the memory 1005 via the bus 1001. The memory 1005 includes both dynamic memory (e.g., RAM, magnetic disk, writable optical disk, etc.) and static memory (e.g., ROM, CD-ROM, etc.) for storing executable instructions that when executed perform the inventive steps described herein to subscribing to notifications based on operations associated with content items. The memory 1005 also stores the data associated with or generated by the execution of the inventive steps.

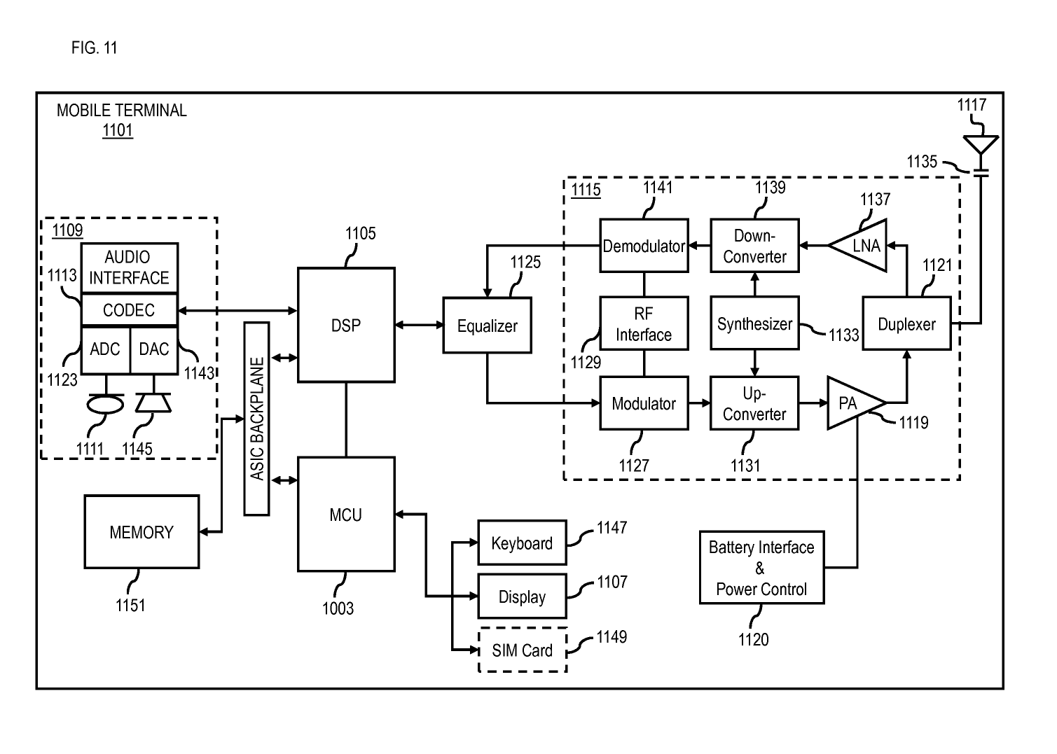

FIG. 11 is a diagram of exemplary components of a mobile terminal (e.g., handset) for communications, which is capable of operating in the system of FIG. 1, according to one embodiment. In some embodiments, mobile terminal 1101, or a portion thereof, constitutes a means for performing one or more steps of subscribing to notifications based on operations associated with content items. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 1103, a Digital Signal Processor (DSP) 1105, and a receiver/transmitter unit including a microphone gain control unit and a speaker gain control unit. A main display unit 1107 provides a display to the user in support of various applications and mobile terminal functions that perform or support the steps of subscribing to notifications based on operations associated with content items. The display 1107 includes display circuitry configured to display at least a portion of a user interface of the mobile terminal (e.g., mobile telephone). Additionally, the display 1107 and display circuitry are configured to facilitate user control of at least some functions of the mobile terminal. An audio function circuitry 1109 includes a microphone 1111 and microphone amplifier that amplifies the speech signal output from the microphone 1111. The amplified speech signal output from the microphone 1111 is fed to a coder/decoder (CODEC) 1113.

A radio section 1115 amplifies power and converts frequency in order to communicate with a base station, which is included in a mobile communication system, via antenna 1117. The power amplifier (PA) 1119 and the transmitter/modulation circuitry are operationally responsive to the MCU 1103, with an output from the PA 1119 coupled to the duplexer 1121 or circulator or antenna switch, as known in the art. The PA 1119 also couples to a battery interface and power control unit 1120.

In use, a user of mobile terminal 1101 speaks into the microphone 1111 and his or her voice along with any detected background noise is converted into an analog voltage. The analog voltage is then converted into a digital signal through the Analog to Digital Converter (ADC) 1123. The control unit 1103 routes the digital signal into the DSP 1105 for processing therein, such as speech encoding, channel encoding, encrypting, and interleaving. In one embodiment, the processed voice signals are encoded, by units not separately shown, using a cellular transmission protocol such as enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like, or any combination thereof.

The encoded signals are then routed to an equalizer 1125 for compensation of any frequency-dependent impairments that occur during transmission though the air such as phase and amplitude distortion. After equalizing the bit stream, the modulator 1127 combines the signal with a RF signal generated in the RF interface 1129. The modulator 1127 generates a sine wave by way of frequency or phase modulation. In order to prepare the signal for transmission, an up-converter 1131 combines the sine wave output from the modulator 1127 with another sine wave generated by a synthesizer 1133 to achieve the desired frequency of transmission. The signal is then sent through a PA 1119 to increase the signal to an appropriate power level. In practical systems, the PA 1119 acts as a variable gain amplifier whose gain is controlled by the DSP 1105 from information received from a network base station. The signal is then filtered within the duplexer 1121 and optionally sent to an antenna coupler 1135 to match impedances to provide maximum power transfer. Finally, the signal is transmitted via antenna 1117 to a local base station. An automatic gain control (AGC) can be supplied to control the gain of the final stages of the receiver. The signals may be forwarded from there to a remote telephone which may be another cellular telephone, any other mobile phone or a land-line connected to a Public Switched Telephone Network (PSTN), or other telephony networks.

Voice signals transmitted to the mobile terminal 1101 are received via antenna 1117 and immediately amplified by a low noise amplifier (LNA) 1137. A down-converter 1139 lowers the carrier frequency while the demodulator 1141 strips away the RF leaving only a digital bit stream. The signal then goes through the equalizer 1125 and is processed by the DSP 1105. A Digital to Analog Converter (DAC) 1143 converts the signal and the resulting output is transmitted to the user through the speaker 1145, all under control of a Main Control Unit (MCU) 1103 which can be implemented as a Central Processing Unit (CPU).

The MCU 1103 receives various signals including input signals from the keyboard 1147. The keyboard 1147 and/or the MCU 1103 in combination with other user input components (e.g., the microphone 1111) comprise a user interface circuitry for managing user input. The MCU 1103 runs a user interface software to facilitate user control of at least some functions of the mobile terminal 1101 to subscribing to notifications based on operations associated with content items. The MCU 1103 also delivers a display command and a switch command to the display 1107 and to the speech output switching controller, respectively. Further, the MCU 1103 exchanges information with the DSP 1105 and can access an optionally incorporated SIM card 1149 and a memory 1151. In addition, the MCU 1103 executes various control functions required of the terminal. The DSP 1105 may, depending upon the implementation, perform any of a variety of conventional digital processing functions on the voice signals. Additionally, DSP 1105 determines the background noise level of the local environment from the signals detected by microphone 1111 and sets the gain of microphone 1111 to a level selected to compensate for the natural tendency of the user of the mobile terminal 1101.

The CODEC 1113 includes the ADC 1123 and DAC 1143. The memory 1151 stores various data including call incoming tone data and is capable of storing other data including music data received via, e.g., the global Internet. The software module could reside in RAM memory, flash memory, registers, or any other form of writable storage medium known in the art. The memory device 1151 may be, but not limited to, a single memory, CD, DVD, ROM, RAM, EEPROM, optical storage, magnetic disk storage, flash memory storage, or any other non-volatile storage medium capable of storing digital data.

An optionally incorporated SIM card 1149 carries, for instance, important information, such as the cellular phone number, the carrier supplying service, subscription details, and security information. The SIM card 1149 serves primarily to identify the mobile terminal 1101 on a radio network. The card 1149 also contains a memory for storing a personal telephone number registry, text messages, and user specific mobile terminal settings.

Further, one or more camera sensors 1153 may be incorporated onto the mobile station 1101 wherein the one or more camera sensors may be placed at one or more locations on the mobile station. Generally, the camera sensors may be utilized to capture, record, and cause to store one or more still and/or moving images (e.g., videos, movies, etc.) which also may comprise audio recordings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

1. A method comprising facilitating a processing of and/or processing (1) data and/or (2) information and/or (3) at least one signal, the (1) data and/or (2) information and/or (3) at least one signal based, at least in part, on the following:
at least one determination at least one operation by at least one device associated with one or more content items;
a processing of the one or more content items to determine at least one identification code; and
a subscription to at least one notification channel associated with the one or more content items, one or more entities associated with the one or more content items, or a combination thereof based, at least in part, on the at least one identification code.

2. A method of claim 1, wherein the one or more content items include, at least in part, one or more web bookmarks, and wherein the at least one operation includes, at least in part, a creation of the one or more web bookmarks.

3. A method of claim 1, wherein the determining of the at least one operation, the determining of the at least one identification code, the subscription to the at least one notification channel, or a combination thereof is performed by at least one notification enabler.

4. A method of claim 3, wherein the at least one notification enabler is a separate component from one or more other components associated with performing the at least one operation, presenting the one or more content items, or a combination thereof.

5. A method of claim 1, wherein the (1) data and/or (2) information and/or (3) at least one signal are further based, at least in part, on the following:
an encryption of the at least one identification code,
wherein the one or more content items are associated with the at least one identification code in an encrypted form.

6. A method of claim 1, wherein the (1) data and/or (2) information and/or (3) at least one signal are further based, at least in part, on the following:
a presentation of at least one console interface for exchanging one or more messages over the at least one notification channel.

7. A method of claim 6, wherein the (1) data and/or (2) information and/or (3) at least one signal are further based, at least in part, on the following:
at least one determination of one or more entities associated with the one or more content items, the at least one notification channel, or a combination thereof; and
an authentication of the one or more entities for access to the at least one console interface, the at least one notification channel, or a combination thereof.

8. A method of claim 7, wherein the (1) data and/or (2) information and/or (3) at least one signal are further based, at least in part, on the following:
a request for a registration of the one or more entities, the one or more content items, or a combination thereof; and
a generation of the at least one identification code for the one or more entities to include with the one or more content items.

9. A method of claim 8, wherein the (1) data and/or (2) information and/or (3) at least one signal are further based, at least in part, on the following:
another request from the one or more entities to transmit one or more messages over the at least one notification channel; and
a transmission of the one or more messages over the at least one notification channel based, at least in part, on the authentication.

10. A method of claim 9, wherein the (1) data and/or (2) information and/or (3) at least one signal are further based, at least in part, on the following:
a processing of the another request to determine at least one request identification code,
wherein the authentication is based, at least in part, on a comparison of the at least one request identification code against the at least one identification code determined from the one or more content items.

11. An apparatus comprising:
at least one processor; and
at least one memory including computer program code for one or more programs,
the at least one memory and the computer program code configured to, with the at least one processor, cause the apparatus to perform at least the following,
determine at least one operation by at least one device associated with one or more content items;
process and/or facilitate a processing of the one or more content items to determine at least one identification code; and
cause, at least in part, a subscription to at least one notification channel associated with the one or more content items, one or more entities associated with the one or more content items, or a combination thereof based, at least in part, on the at least one identification code.

12. An apparatus of claim 11, wherein the one or more content items include, at least in part, one or more web bookmarks, and wherein the at least one operation includes, at least in part, a creation of the one or more web bookmarks.

13. An apparatus of claim 11, wherein the determining of the at least one operation, the determining of the at least one identification code, the subscription to the at least one notification channel, or a combination thereof is performed by at least one notification enabler.

14. An apparatus of claim 13, wherein the at least one notification enabler is a separate component from one or more other components associated with performing the at least one operation, presenting the one or more content items, or a combination thereof.

15. An apparatus of claim 11, wherein the apparatus is further caused to:
cause, at least in part, an encryption of the at least one identification code,
wherein the one or more content items are associated with the at least one identification code in an encrypted form.

16. An apparatus of claim 11, wherein the apparatus is further caused to:
cause, at least in part, a presentation of at least one console interface for exchanging one or more messages over the at least one notification channel.

17. An apparatus of claim 16, wherein the apparatus is further caused to:
determine one or more entities associated with the one or more content items, the at least one notification channel, or a combination thereof; and
cause, at least in part, an authentication of the one or more entities for access to the at least one console interface, the at least one notification channel, or a combination thereof.

18. An apparatus of claim 17, wherein the apparatus is further caused to:
determine a request for a registration of the one or more entities, the one or more content items, or a combination thereof; and
cause, at least in part, a generation of the at least one identification code for the one or more entities to include with the one or more content items.

19. An apparatus of claim 18, wherein the apparatus is further caused to:
determine another request from the one or more entities to transmit one or more messages over the at least one notification channel; and
cause, at least in part, a transmission of the one or more messages over the at least one notification channel based, at least in part, on the authentication.

20. An apparatus of claim 19, wherein the apparatus is further caused to:
process and/or facilitate a processing of the another request to determine at least one request identification code,
wherein the authentication is based, at least in part, on a comparison of the at least one request identification code against the at least one identification code determined from the one or more content items.

21-48. (canceled)
